(19) United States
(12) Patent Application Publication
(10) Pub. No.: US 2026/0220310 A1
(43) Pub. Date: Jul. 30, 2026

(54) HARDWARE-BASED DATA PROTECTION FOR REPLAY PROTECTED DATA

(71) Applicant: QUALCOMM Incorporated, San Diego, CA (US)

(72) Inventors: Sridhar Anumala, Hyderabad (IN); Can Guo, Shanghai (CN); Richard Patrick, San Diego, CA (US); Asutosh Das, San Diego, CA (US); Madhu Yashwanth Boenapalli, Hyderabad (IN); Yashavantha Rao, Bangalore (IN)

(21) Appl. No.: 19/145,168

(22) PCT Filed: Feb. 10, 2023
(86) PCT No.: PCT/CN2023/075361

§ 371 Date: Jul. 1, 2025

(51) Int. Cl. G06F 21/78; G06F 21/60; H04L 9/08

(52) U.S. Cl. CPC G06F 21/78; G06F 21/602; H04L 9/0869

(57) ABSTRACT

This disclosure provides systems, methods, and devices for memory systems that support encrypted data in transit for Replay Protected Memory Blocks (RPMBs). In a first aspect, a method of processing data for a memory system includes receiving an authentication key from a host device for authenticating access to data stored in a portion of the memory module; deriving an encryption key based on the authentication key; and processing data transmitted on a first interface between the host device and the memory system based on the encryption key. Other aspects and features are also claimed and described.

### TECHNICAL FIELD

Aspects of the present disclosure relate generally to an apparatus and method for controlling a memory device. Some aspects may, more particularly, relate to an apparatus and method for controlling operations for encryption of data communicated to a memory storage device.

### INTRODUCTION

As the value and use of information continues to increase, individuals and businesses seek additional ways to process and store information. In addition, the use of information in various locations and desired portability of information is increasing. For this reason, users are increasingly turning towards the use of portable electronic devices, such as mobile phones, digital cameras, laptop computers and the like. Portable electronic devices generally employ a memory system using a memory device for storing data. A memory system may be used as a main memory or an auxiliary memory of a portable electronic device.

The memory device of the memory system may include one kind or a combination of kinds of storage. For example, magnetic-based memory systems, such as hard disk drives (HDDs), store data by encoding data as a combination of small magnets. As another example, optical-based memory systems, such as digital versatile discs (DVDs) and Blu-ray media, store data by encoding data as physical bits that cause different reflections when illuminated by a light source. As a further example, electronic memory devices store data as collections of electrons that can be detected through voltage and/or current measurements.

Electronic memory devices can be advantageous in certain systems in that they may access data quickly and consume a small amount of power. Examples of an electronic memory device having these advantages include universal serial bus (USB) memory devices (sometimes referred to as “memory sticks”), a memory card (such as used in some cameras and gaming systems), and solid state drive (SSDs) (such as used in laptop computers). NAND flash memory is one kind of memory device that may be used in electronic memory devices. NAND flash memory is manufactured into memory cards or flash disks. Example memory cards include compact flash (CF) cards, multimedia cards (eMMCs), smart media (SM) cards, and secure digital (SD) cards.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Information transferred between a memory device and other components in an electronic device is subject to spying by a person who should not have access to the data. Although the channels carrying a user's data within an electronic device may not be readily visible or exposed, a skilled threat actor can easily access the channels and execute snooping attacks that expose a user's secure sensitive data. According to aspects of this disclosure, encryption is applied to the data during transit from the memory device to other components. Encrypted data appears unintelligible to recipients other than the intended recipient, thus preventing a snooping attack from providing the user's data to the threat actor. Aspects of this disclosure describe systems and methods for encrypting data transmitted to and from a memory storage device to improve security of a user's data. Some of these aspects include provisioning of keys to components, deriving an encryption key from other keys in components, applying encryption to particular regions of data in a storage device such as a Replay Protected Memory Block (RPMB) of a universal flash storage (UFS) device, or combinations thereof.

In one aspect of the disclosure, a memory device includes a memory controller: coupled to a memory module through a first channel and configured to access data stored in the memory module through the first channel; and coupled to a host device through a first interface and configured to communicate with the host device over the first interface. The memory controller may be configured to perform operations including receiving a seed key from a host device; deriving an authentication key based on the seed key, the authentication key for authenticating access to data stored in a replay protection memory block (RPMB) portion of the memory module; controlling access to the RPMB portion of the memory module based on the authentication key; deriving an encryption key based on the seed key; and processing data on the first interface based on the encryption key

In an additional aspect of the disclosure, an apparatus includes at least one processor and a memory coupled to the at least one processor. The at least one processor is configured to receiving, at a memory controller of a memory system, a seed key from a host device over a first interface between the memory controller and the host device; deriving, at the memory controller, an authentication key based on the seed key, the authentication key for authenticating access to data stored in a replay protection memory block (RPMB) portion of a memory module coupled to the memory controller through a first channel; deriving, by the memory controller, an encryption key based on the seed key; and processing, by the memory controller, data on the first interface based on the encryption key.

In an additional aspect of the disclosure, an apparatus includes a memory controller of a host device configured to couple the host device to a memory system through a first interface, the memory controller configured to perform operations including determining a seed key; deriving an authentication key based on the seed key, the authentication key for authenticating access to data stored in a replay protection memory block (RPMB) portion of the memory system; deriving an encryption key based on the seed key; and processing data on the first interface based on the encryption key.

In an additional aspect of the disclosure, a non-transitory computer-readable medium stores instructions that, when executed by a processor, cause the processor to perform operations. The operations include determining, at a memory controller of a host device, a seed key; deriving, by the memory controller of the host device, an authentication key based on the seed key, the authentication key for authenticating access to data stored in a replay protection memory block (RPMB) portion of a memory system; deriving, by the memory controller of the host device, an encryption key based on the authentication key; and processing, by the memory controller of the host device, data on a first interface coupling the memory controller of the host device to a memory system, wherein the processing of the data is based on the encryption key.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating a data processing system including a memory system in accordance with an embodiment of the present invention.

FIG. 2 is a block diagram illustrating an example electronic device including the memory system according to one or more aspects of the disclosure.

FIG. 3 is a block diagram illustrating an electronic device with an encrypted channel to a storage device's replay protected memory bank (RPMB) according to one or more aspects of the disclosure.

FIG. 4 is a call flow diagram illustrating encryption of data in transit with the memory storage device according to one or more aspects of the disclosure.

FIG. 5 is a flow chart illustrating a method for processing data on an interface between host device and memory system with two keys according to one or more aspects of the disclosure.

FIG. 6 is a block diagram illustrating details of an example wireless communication system according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support data processing, including techniques for storing, retrieving, and organizing data in a memory system. In particular, aspects of this disclosure provide for encryption of data while in transit between components of an electronic device. For example, data on a physical channel between the host device and the memory system's Replay Protected Memory Block (RPMB) may be encrypted.

Particular implementations of the subject matter described in this disclosure may be implemented to realize one or more of the following potential advantages or benefits. In some aspects, the present disclosure provides techniques for improved confidentiality of user data by reducing the likelihood of, or preventing, a threat actor obtaining the user's data by snooping the channel. The present disclosure may provide additional benefits such as reducing the likelihood of an unauthenticated user of the memory system (e.g., an application or virtual machine executing on the host device) from gaining access to a protected region of the memory system (e.g., RPMBs assigned to other applications or virtual machines).

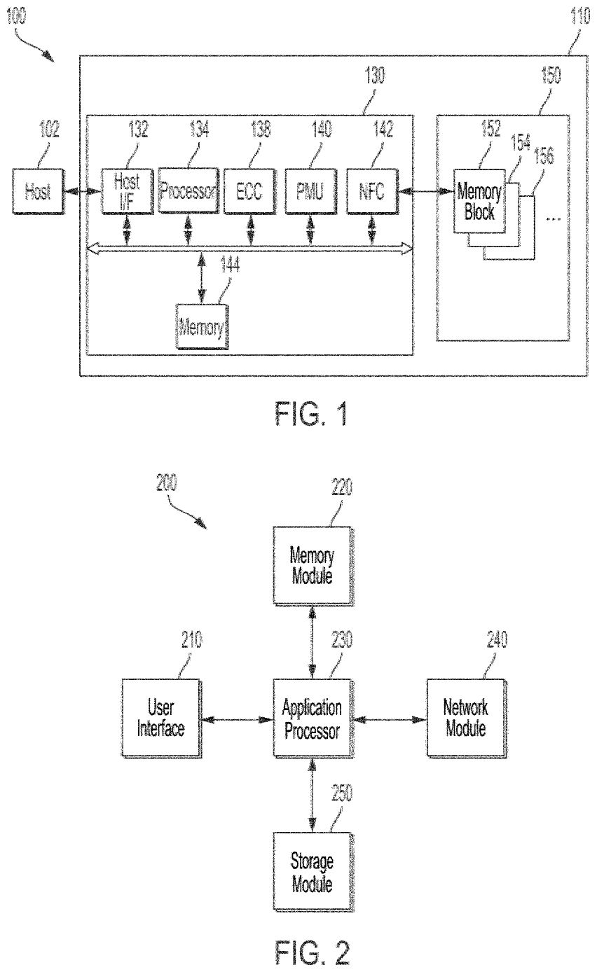

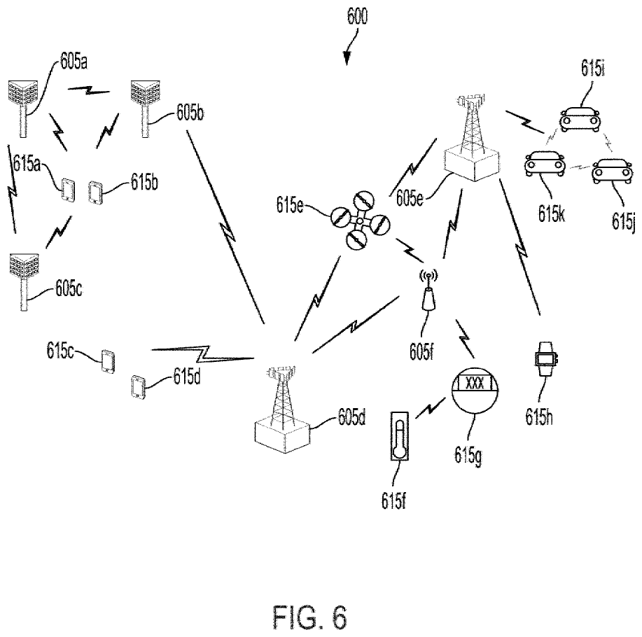

Memory may be used in a computing system organized as illustrated in FIG. 1. FIG. 1 illustrates a data processing system 100, such as may be included in a mobile computing device, according to one or more aspects of the disclosure. A memory system 110 may couple to a host device 102 through one or more channels. For example, the host device 102 and memory system 110 may be coupled through a serial interface including a single channel for the transport of data or a parallel interface including two or more channels for the transport of data. In some aspects, control data may be transferred through the same channel(s) as the data or the control data may be transferred through additional channels. The host device 102 may be, for example, a system-on-chip (SoC), a portable electronic device such as a mobile phone, an MP3 player, a laptop computer, or a non-portable electronic device such as a desktop computer, a game player, a television (TV), a media player, or a projector. Additional example host devices are illustrated and described with reference to FIG. 6.

The memory system 110 may execute operations in response to commands (e.g., a request) from the host device 102. For example, the memory system 110 may store data provided by the host 102 and the memory system 110 may also provide stored data to the host 102. The memory system 110 may be used as a main memory, short-term memory, or long-term memory by the host device 102. As one example of main memory, the host device 102 may use the memory system 110 to supplement or replace a system memory by using the memory system 110 to store temporary data such as data relating to operating systems and/or threads executing in the operation system. As one example of short-term memory, the host device 102 may use the memory system 110 to store a page file for an operating system. As one example of long-term memory, the host device 102 may use the memory system 110 to store user files (e.g., documents, videos, pictures) and/or application files (e.g., word processing executable, gaming application).

The memory system 110 may be implemented with any one of various storage devices, according to the protocol of a host interface for the one or more channels coupling the memory system 110 to the host device 102. The memory system 110 may be implemented with any one of various storage devices, such as a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, or a memory stick.

The memory system 110 may include a memory portion 150 and a controller portion 130 coupled to the memory portion 150 through one or more channels. The memory 150 may store and retrieve data under control of the controller 130, which may execute commands received from the host device 102. The controller 130 is configured to control data exchange between the memory device 150 and the host 102. The storage components in the memory 150 may be implemented as volatile memory device, such as, a dynamic random access memory (DRAM) and a static random access memory (SRAM), or a non-volatile memory device, such as a read only memory (ROM), a programmable ROM (PROM), an erasable programmable ROM (EPROM), an electrically erasable programmable ROM (EEPROM), a ferroelectric random access memory (FRAM), a phase-change RAM (PRAM), a magnetoresistive RAM (MRAM), a resistive RAM (SCRAM), or a flash memory.

The controller 130 and the memory 150 may be formed as integrated circuits on one or more semiconductor dies (or other substrate). In some aspects, the controller 130 and the memory 150 may be integrated into one chip. In some aspects, the memory 150 may include one or more chips coupled in series or parallel with each other and coupled to the controller 130, which is on a separate chip. In some aspects, the memory 150 and controller 130 chips are integrated in a single package, such as in a package on package (PoP) system. In some aspects, the memory system 110 is integrated on a single chip with one or more or all of the components (e.g., application processor, system memory, digital signal processor, modem, graphics processor unit, memory interface, input/output interface, network adaptor) of the host device 102, such as in a system on chip (SoC). The controller 130 and the memory 150 may be integrated into one semiconductor device to form a memory card, such as, for example, a Personal Computer Memory Card International Association (PCMCIA) card, a compact flash (CF) card, a smart media card (SMC), a memory stick, a multimedia card (MMC), an RS-MMC, a micro-MMC, a secure digital (SD) card, a mini-SD, a micro-SD, an SDHC, and a universal flash storage (UFS) device.

The controller 130 of the memory system 110 may control the memory 150 in response to commands from the host device 102. The controller 130 may execute read commands to provide the data from the memory 150 to the host device 102, and execute write commands to store data provided from the host device 102 into the memory 150. The controller 130 may execute other commands to manage data in the memory 150, such as program and erase commands. The controller 130 may also execute other commands to manage control of the memory system 110, such as setting configuration registers of the memory system 110. By executing commands in accordance with the configuration specified in the configuration registers, the controller 130 may control operations of the memory device 150, such as read, write, program, and erase operations.

The controller 130 may include several components configured for performing the received commands. For example, the controller 130 may include a host interface (I/F) unit 132, a processor 134, an error correction code (ECC) unit 138, a power management unit (PMU) 140, a NAND flash controller (NFC) 142, and/or a memory 144. The power management unit (PMU) 140 may provide and manage power for components within the controller 130.

The host interface unit 132 may process commands and data provided from the host device 102, and may communicate with the host device 102, through at least one of various interface protocols such as universal serial bus (USB), multimedia card (MMC), peripheral component interconnect express (PCI-e), serial attached SCSI (SAS), serial advanced technology attachment (SATA), parallel advanced technology attachment (PATA), small computer system interface (SCSI), enhanced small disk interface (ESDI), and integrated drive electronics (IDE). For example, the host interface 6431 may be a parallel interface such as an MMC interface, or a serial interface such as an ultra-high speed class 1 (UHS-I)/UHS class 2 (UHS-II) and a universal flash storage (UFS) interface.

The ECC unit 138 may detect and correct errors in the data read from the memory device 150 during the read operation. The ECC unit 138 may not correct error bits when the number of the error bits is greater than a threshold number of correctable error bits, then may output an error correction fail signal indicating failure in correcting the error bits. In some aspects, no ECC unit 138 may be provided or the ECC unit 138 may be configurable to be active for some or all of the memory 150. The ECC unit 138 may perform an error correction operation using a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), or a Block coded modulation (BCM).

The NFC 142 provides an interface between the controller 130 and the memory 150 to allow the controller 130 to control the memory device 150 in response to a commands received from the host device 102. The NFC 142 may generate control signals for the memory 150, such as signals for rowlines and bitlines, and process data under the control of the processor 134. Although NFC 142 is described as a NAND flash controller, other controllers may perform similar function for other memory types used as memory 150.

The memory 144 may serve as a working memory of the memory system 110 and the controller 130. The memory 144 may store data for driving the memory system 110 and the controller 130. When the controller 130 controls an operation of the memory device 150 such as, for example, a read, write, program and erase operation, the memory 144 may store data which are used by the controller 130 and the memory device 150 for the operation. The memory 144 may be implemented with a volatile memory such as, for example, a static random access memory (SRAM) or a dynamic random access memory (DRAM). In some aspects, the memory 144 may store address mappings, a program memory, a data memory, a write buffer, a read buffer, a map buffer, and the like.

The processor 134 may control the general operations of the memory system 110, and a write operation or a read operation for the memory device 150, in response to a write request or a read request received from the host 102, respectively. For example, the processor 134 may execute firmware, which is referred to as a flash translation layer (FTL), to control the general operations of the memory system 110. The processor 134 may be implemented, for example, with a microprocessor or a central processing unit (CPU), or an application-specific integrated circuit (ASIC).

FIG. 2 is a block diagram illustrating an example electronic device including the memory system according to one or more aspects of the disclosure. The electronic device 200 may include a user interface 210, a memory module 220, an application processor 230, a network adaptor 240, and a storage device 250.

The application processor 230 may execute computer program code, including applications, drivers, and operating systems, to coordinate performing of tasks by components included in the electronic device 200. The application processor 230 may be part of a system-on-chip (SoC) that includes one or more other components shown in electronic device 200.

The memory module 220 may operate as a main memory, a working memory, a buffer memory or a cache memory of the electronic device 200. The memory module 220 may include a volatile random access memory such as a dynamic random access memory (DRAM), a synchronous dynamic random access memory (SDRAM), a double data rate (DDR) SDRAM, a DDR2 SDRAM, a DDR3 SDRAM, a low power double data rate (LPDDR) SDRAM, an LPDDR2 SDRAM, an LPDDR3 SDRAM, an LPDDR4 SDRAM, an LPDDR5 SDRAM, or an LPDDR6 SDRAM, or a nonvolatile random access memory such as a phase change random access memory (PRAM), a resistive random access memory (ReRAM), a magnetic random access memory (MRAM) and a ferroelectric random access memory (FRAM). In some aspects, the application processor 230 and the memory module 220 may be combined using a package-on-package (POP).

The network adaptor 240 may communicate with external devices. For example, the network adaptor 240 may support wired communications and/or various wireless communications such as code division multiple access (CDMA), global system for mobile communication (GSM), wideband CDMA (WCDMA), CDMA-2000, time division multiple access (TDMA), long term evolution (LTE), worldwide interoperability for microwave access (WiMAX), wireless local area network (WLAN), ultra-wideband (UWB), Bluetooth, wireless display (WI-DI), and so on, and may thereby communicate with wired and/or wireless electronic appliances, for example, a mobile electronic appliance.

The storage device 250 may store data, for example, data received from the application processor 230, and transmit data stored therein, to the application processor 230. The storage device 250 may be a non-volatile semiconductor memory device, such as a phase-change RAM (PRAM), a magnetic RAM (MRAM), a resistive RAM (ReRAM), a NAND flash memory, a NOR flash memory, or a 3-dimensional (3-D) NAND flash memory. The storage device 250 may be a removable storage medium, such as a memory card or an external drive. For example, the storage device 250 may correspond to the memory system 110 described above with reference to FIG. 1 and may be a SSD, eMMC, or UFS.

The user interface 210 provide one or more graphical user interfaces (GUIs) for inputting data or commands to the application processor 230 or for outputting data to an external device. For example, the user interface 210 may include user input interfaces, such as a virtual keyboard, a touch screen, a camera, a microphone, a gyroscope sensor, or a vibration sensor, and user output interfaces, such as a liquid crystal display (LCD), an organic light emitting diode (OLED) display device, an active matrix OLED (AMOLED) display device, a light emitting diode (LED), a speaker, or a haptic motor.

Encryption may be used to secure data on interfaces between components. Unencrypted data may be subject to snooping or other physical attacks, in which eavesdroppers obtain the unencrypted data while the data is in transit over an interface. When a storage device is a separate physical piece from the rest of the electronic device, the data transmission between the storage device and the electronic device may be particularly vulnerable. Data that is encrypted over the interface, although subject to snooping, results in garbled data that is unintelligible to the eavesdropper.

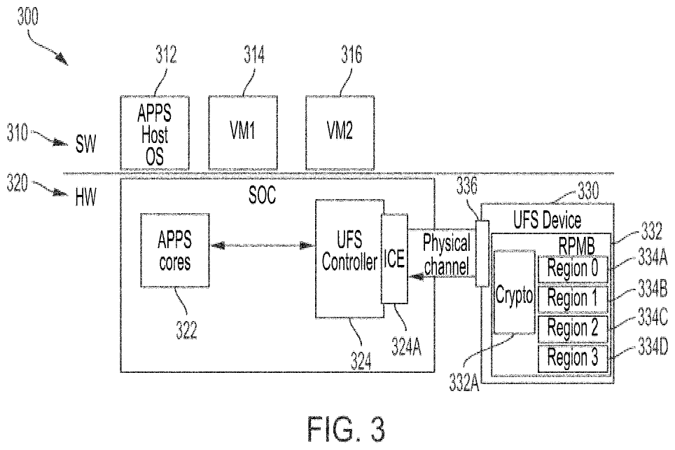

One electronic device with encryption protecting a memory interface is shown in FIG. 3. FIG. 3 is a block diagram illustrating an electronic device with an encrypted channel to a storage device according to one or more aspects of the disclosure. An electronic device 300 may include software 310 executing on hardware 320. The software 310 may include applications 312 executing in a host operating system and/or one or more virtual machines 314, 316. The software 310 may execute on application processor cores 322 in a system-on-chip (SoC). The SoC may also include a universal flash storage (UFS) controller 324 that provides an interface between the application processor cores 322 and a UFS device 330 over one or more channels. The UFS controller 324 may include an in-line cryptography engine (ICE) 324A for encrypting data transmitted over a physical channel to the UFS device 330. The ICE 324A may include a memory portion for key space memory to store authentication and/or encryption keys. Although a UFS controller 324 and UFS device 330 are illustrated in the example of FIG. 3, the encryption aspects described herein may be applied to other memory systems, including any of the memory systems described with reference to FIG. 1.

The UFS device 330 may include a controller 336 for interfacing over the physical channel with the UFS controller 324. The UFS device 330 may also include a Replay Protected Memory Block (RPMB) 332 configured to store application secure data that provides replay protection. For example, RPMB 332 may protect data written in certain regions from being overwritten (such as through a Write Protect Until Power Cycle or Permanent Write Protect status). RPMB 332 may be used by software to reduce or prevent a downgrade attack that overwrites a software version authentication or may be used by software for secure boot that prevents undesired code from running on a device.

The RPMB 332 may include one or more defined regions 334A-D accessible through a cryptography engine 332A. The regions 334A-D may be a portion of one of the memory blocks 152, 154, 156 of FIG. 1 or may be one of the memory blocks 152, 154, 156 dedicated to RPMB. The cryptography engine 332A may restrict access to regions 334A-D to an authorized user and encrypt data from the regions 334A-D before transmission over the physical channel to the UFS controller 324. The regions 334A-D may be used by the software 310 to store information relating to digital rights management (RDM) (e.g., keys for accessing protected media content in a media player application), biometric data (e.g., fingerprints, face authentication data, iris authentication data), and/or software roll-back versions (e.g., anti-rollback versions of trusted applications). The cryptography engine 332A may include a key memory space for storing the authorization or encryption key. They key memory space may be sized or allocated from a shared memory to be the combined size of the first and encryption keys (e.g., 256 bits or 512 bits) multiplied by the number of regions 334A-D.

The encryption applied to data transmitted over the physical channel may be based on a confidentiality algorithm. For example, the ICE 324A and/or the cryptography engine 332A may execute one or more algorithms include AES-XTS, CBC, and SHA256-HMAC. In some aspects, the ICE 324A and cryptography engine 332A may include dedicate logic for performing encryption and/or decryption of one or more confidentiality algorithms. During an RPMB Write Operation executed by the UFS controller 324 on the UFS device 330, the UFS controller ICE 324A may encrypt RPMB data packets assembled by the software 310 and the UFS device 330 may decrypt the content to obtain the RPMB packet for storage. During an RPMB Read Operation executed by the UFS controller 324 on the UFS device 330, the UFS device's cryptography engine 332A is configured to encrypt the data from regions 334A-D, and the UFS controller ICE 324A is configured to decrypt the content and provide the data to the software 310.

Within the RPMB 332, certain regions may be assigned for exclusive access to certain users (e.g., one or application 312 or virtual machine 314, 316). An authentication key may be used to restrict access to a region to an authorized application or virtual machine. The authentication key may be provisioned by one of the application 312 or virtual machines 314, 316 to secure one of the regions 334A-D for exclusive access. The encryption applied to data in transit over the physical channel may be derived from the authentication key. For example, virtual machine 314 may provision an authentication key in RPMB 332 for region 334A. The cryptography engine 332A in the UFS device 330 may derive an encryption key for encryption from the authentication key. The cryptography engine 332A uses the derived key for encrypting data in cryptography engine 332A or controller 336 before transmission over the physical channel to the UFS controller 324. The encrypted data received at the UFS controller 324 may be decrypted by the USF controller 324, such as in ICE 324A, and delivered to the requesting software 310. The encrypted data may alternatively be received at the UFS controller 324 and delivered to the requested software 310 as encrypted data, and the requesting software 310 may decrypt the data. The UFS controller 324 or the requesting software 310 may derive a decryption key from the authentication key in a parallel process to the derivation of the encryption key in the UFS device 330.

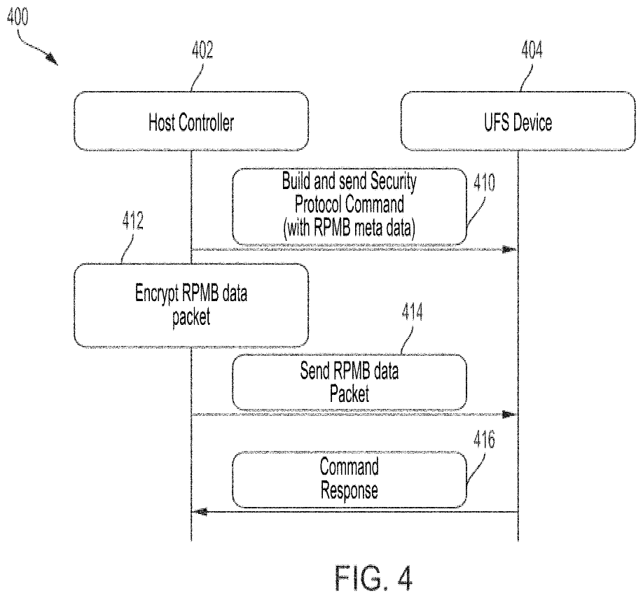

An example communication session using encryption to transport the RPMB data between a host device and a memory storage device is shown in FIG. 4. FIG. 4 is a call flow diagram illustrating encryption of data in transit with the memory storage device according to one or more aspects of the disclosure. Calls 400 are illustrated between a host controller 402 (e.g., UFS controller 324 of FIG. 3) and a UFS device 404 (e.g., UFS device 330 of FIG. 3). A first call 410 begins with the host controller 402 building and sending a security protocol command with RPMB meta data. Call 410 may establish a region of the UFS device 404 for secure access by a particular application accessing data through the host controller 402. At block 412, the host controller 402 encrypts a RPMB data packet, which is transmitted to the UFS device at call 414. Encryption at block 412 may be performed using an encryption key derived from an authentication key, such as a key used to build the security protocol command at call 410. If a threat actor is able to acquire the encrypted data, the user's data is not exposed because the data is unintelligible without the encryption key. The UFS device 404 responds to the host controller 402 at call 416 to indicate an outcome of the command, such as to indicate a success, a failure, or other information regarding the execution of the RPMB Write Operation or a status of the UFS device 404.

FIG. 4 illustrates an example RPMB Write Operation executed by the host device for storing data in a RPMB Region of the memory storage device. During the RPMB Write Operation, a UFS controller ICE may be used for the software applications to encrypt the RPMB data packets, and the receiver-end UFS device decrypts the content. A cryptography engine of the UFS device may be configured to execute one or more of a set of confidentiality algorithms for the decryption. A similar process may be performed for executing a RPMB Read Operation to retrieve data from a RPMB region. During an RPMB Read Operation, a UFS device's cryptography engine may encrypt data retrieved from an RPMB region, and the receiver-end UFS controller ICE may decrypt the content for software applications.

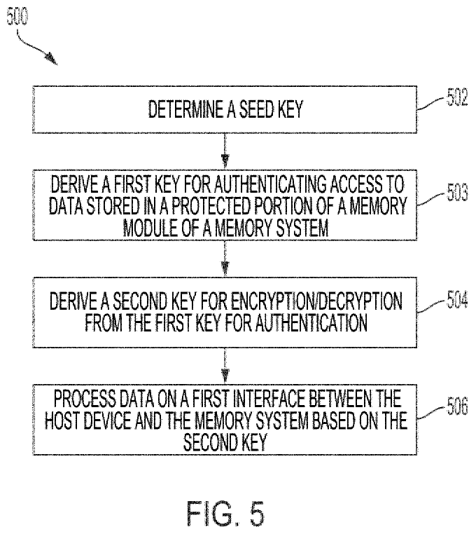

An example method for using multiple keys when transferring data between a host device and a memory system in accordance with the RPMB Write Operation and RPMB Read Operation examples is shown in FIG. 5. FIG. 5 is a flow chart illustrating a method for processing data on an interface between host device and memory system with two keys according to one or more aspects of the disclosure. A method 500 includes, at block 502, a seed key is determined, such as by the host device generating the seed key from a randomization function or the memory device receiving the seed key from the host device. The authentication key may be used for authenticating access to data stored in a protected portion (e.g., a RPMB portion) of a memory module of a memory system.

At block 503, the authentication key may be derived from the seed key. In one example derivation, the authentication key may be used as a seed in a key derivation function (KDF), which may be based on a cryptographic hash function such as SHA-2, SHA-3, HMAC-SHA256, or HMAC-SHA3-512.

At block 504, the seed key may be used to derive an encryption key for use in processing data on the first interface when communicating data in the protected portion on the first interface. In one example derivation, the encryption key may be derived from the seed key based on a key derivation function (KDF), which may be based on a cryptographic hash function such as SHA-2, SHA-3, HMAC-SHA256, or HMAC-SHA3-512. Both the host device and the memory system may execute the KDF with the seed key to derive the authentication and encryption keys.

In some aspects, a handshake process may be used to synchronize or otherwise align the derivation process in the memory controller of the host device and the memory controller of the memory system. For example, a seed value may be established on both memory controllers to synchronize the derivation process, in which the seed key of block 502 is transmitted from the memory controller of the host device to the memory controller of the memory system. As another example, a handshake may be used to configure both memory controllers with the same confidentiality algorithm. The encryption key derived by the memory controllers of the host device and the memory system may be programmed on the host device ICE and on the memory system cryptography block, respectively.

At block 506, the data on the first interface is processed based on the encryption key. The encryption key may be used to encrypt/decrypt the data retrieved from the protected region of the memory system or otherwise protect the confidentiality of the data from the protected region. For example, data stored in a Replay Protected Memory Block (RPMB) of the memory system may be encrypted when writing the data from the host device to the memory system (e.g., in a RPMB Write Operation) and/or when reading the data by the host device from the memory system (e.g., in a RPMB Read Operation). In some aspects, the command for a protected read or protected write into the protected region may include a flag indicating whether the data being transmitted (in a write operation) or requested (in a read operation) should be encrypted. Such a flag may reduce power consumed in encrypting and decrypting data that does not need to be protected. In some aspects, whether data is encrypted during transfer over the interface may be specified by the configuration of the protected region. That is, whether the data written into a protected region or retrieved from a protected region is encrypted over the interface may be determined based on the protected region being accessed. The protected regions may be configured for encrypted data-in-motion or unencrypted data-in-motion when the protected region is allocated to a particular application or virtual machine.

Operations of method 500 may be performed by a UE, such as a UE described with reference to FIG. 6. For example, example operations (also referred to as “blocks”) of method 500 may enable UE 115 to support greater user data confidentiality. FIG. 6 is a block diagram illustrating details of an example wireless communication system according to one or more aspects. The wireless communication system may include wireless network 600. Wireless network 600 may, for example, include a 5G wireless network. As appreciated by those skilled in the art, components appearing in FIG. 6 are likely to have related counterparts in other network arrangements including, for example, cellular-style network arrangements and non-cellular-style-network arrangements (e.g., device to device or peer to peer or ad hoc network arrangements, etc.).

Wireless network 600 illustrated in FIG. 6 includes a number of base stations 605 and other network entities. A base station may be a station that communicates with the UEs and may also be referred to as an evolved node B (eNB), a next generation eNB (gNB), an access point, and the like. Each base station 605 may provide communication coverage for a particular geographic area. In 3GPP, the term “cell” may refer to this particular geographic coverage area of a base station or a base station subsystem serving the coverage area, depending on the context in which the term is used. In implementations of wireless network 600 herein, base stations 605 may be associated with a same operator or different operators (e.g., wireless network 600 may include a plurality of operator wireless networks). Additionally, in implementations of wireless network 600 herein, base station 605 may provide wireless communications using one or more of the same frequencies (e.g., one or more frequency bands in licensed spectrum, unlicensed spectrum, or a combination thereof) as a neighboring cell. In some examples, an individual base station 605 or UE 615 may be operated by more than one network operating entity. In some other examples, each base station 605 and UE 615 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 6, base stations 605d and 605e are regular macro base stations, while base stations 605a-605c are macro base stations enabled with one of 3 dimension (3D), full dimension (FD), or massive MIMO. Base stations 605a-605c take advantage of their higher dimension MIMO capabilities to exploit 3D beamforming in both elevation and azimuth beamforming to increase coverage and capacity. Base station 605f is a small cell base station which may be a home node or portable access point. A base station may support one or multiple (e.g., two, three, four, and the like) cells.

Wireless network 600 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 615 are dispersed throughout the wireless network 600, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 615, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 615a-615d of the implementation illustrated in FIG. A are examples of mobile smart phone-type devices accessing wireless network 600. A UE may also be a machine specifically configured for connected communication, including machine type communication (MTC), enhanced MTC (eMTC), narrowband IoT (NB-IoT) and the like. UEs 615e-615k illustrated in FIG. 6 are examples of various machines configured for communication that access wireless network 600.

A mobile apparatus, such as UEs 615, may be able to communicate with any type of the base stations, whether macro base stations, pico base stations, femto base stations, relays, and the like. In FIG. A, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 600 may occur using wired or wireless communication links.

In operation at wireless network 600, base stations 605a-605c serve UEs 615a and 615b using 3D beamforming and coordinated spatial techniques, such as coordinated multipoint (CoMP) or multi-connectivity. Macro base station 605d performs backhaul communications with base stations 605a-605c, as well as small cell, base station 605f. Macro base station 605d also transmits multicast services which are subscribed to and received by UEs 615c and 615d. Such multicast services may include mobile television or stream video, or may include other services for providing community information, such as weather emergencies or alerts, such as Amber alerts or gray alerts.

Wireless network 600 of implementations supports mission critical communications with ultra-reliable and redundant links for mission critical devices, such UE 615e, which is a drone. Redundant communication links with UE 615e include from macro base stations 605d and 605e, as well as small cell base station 605f. Other machine type devices, such as UE 615f (thermometer), UE 615g (smart meter), and UE 615h (wearable device) may communicate through wireless network 600 either directly with base stations, such as small cell base station 605f, and macro base station 605e, or in multi-hop configurations by communicating with another user device which relays its information to the network, such as UE 615f communicating temperature measurement information to the smart meter, UE 615g, which is then reported to the network through small cell base station 605f. Wireless network 600 may also provide additional network efficiency through dynamic, low-latency TDD communications or low-latency FDD communications, such as in a vehicle-to-vehicle (V2V) mesh network between UEs 615i-615k communicating with macro base station 605e.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably. A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards. A TDMA network may, for example implement a radio technology such as Global System for Mobile Communication (GSM). The 3^{rd} Generation Partnership Project (3GPP) defines standards for the GSM EDGE (enhanced data rates for GSM evolution) radio access network (RAN), also denoted as GERAN. An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long-term evolution (LTE) is a release of UMTS that uses E-UTRA. The various different network types may use different radio access technologies (RATs) and RANs.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In one or more aspects, techniques for supporting data storage and/or data transmission, may include additional aspects, such as any single aspect or any combination of aspects described below or in connection with one or more other processes or devices described elsewhere herein. In a first aspect, an electronic device, such as a UE, may include an apparatus as a host device that includes a memory controller coupled to an interface to a memory system, in which the memory system may be integrated with the host device or externally coupled to the host device. The memory system may include a memory controller coupled to a memory module through a first channel and configured to access data stored in the memory module through the first channel and coupled to a host device through a first interface and configured to communicate with the host device over the first interface. The memory controller of the memory system may be configured to perform operations including receiving a seed key from a host device; deriving an authentication key based on the seed key, the authentication key for authenticating access to data stored in a replay protection memory block (RPMB) portion of the memory module; controlling access to the RPMB portion of the memory module based on the authentication key; deriving an encryption key based on the seed key; and processing data on the first interface based on the encryption key. The operations may be executed as part of an initialization operation, a read operation or a write operation.

In a first aspect, the memory controller is further configured to perform operations comprising: authenticating access to the data stored in the RPMB portion of the memory module based on the authentication key; retrieving a portion of the data after authenticating access to the data; encrypting at least a portion of the data based on the encryption key to form encrypted data; and transmitting the encrypted data over the first interface.

In a second aspect, in combination with the first aspect, the RPMB portion of the memory module is configured with a monotonic write counter for replay protection.

In a third aspect, in combination with one or more of the first aspect or the second aspect, transmitting the encrypted data over the first interface prevents snooping of the encrypted data by an unauthorized user.

In a fourth aspect, in combination with one or more of the first aspect through the third aspect, deriving the authentication key comprises executing a key derivation function (KDF) based on the seed key.

In a fifth aspect, in combination with one or more of the first aspect through the fourth aspect, the KDF is based on a cryptographic hash function.

In a sixth aspect, in combination with one or more of the first aspect through the fifth aspect, the memory controller is further configured to perform operations comprising receiving encrypted data over the first interface from the host device; decrypting the encrypted data based on the encryption key to obtain decrypted data; authenticating access to the RPMB portion of the memory module based on the authentication key; and storing the decrypted data to the RPMB portion of the memory module after authenticating access.

In a seventh aspect, in combination with one or more of the first aspect through the sixth aspect, the memory controller comprises a cryptography engine configured to encrypt data retrieved from the portion of the memory module and configured to decrypt data for writing into the portion of the memory module.

In an eighth aspect, in combination with one or more of the first aspect through the seventh aspect, the memory controller is configured to communicate with a memory module comprising a universal flash storage (UFS) device.

In a ninth aspect, in combination with one or more of the first aspect through the eighth aspect, a method includes: receiving, at a memory controller of a memory system, a seed key from a host device over a first interface between the memory controller and the host device; deriving, at the memory controller, an authentication key based on the seed key, the authentication key for authenticating access to data stored in a replay protection memory block (RPMB) portion of a memory module coupled to the memory controller through a first channel; deriving, by the memory controller, an encryption key based on the seed key; and processing, by the memory controller, data on the first interface based on the encryption key.

In a tenth aspect, in combination with one or more of the first aspect through the ninth aspect, the method includes authenticating access to the data stored in the RPMB portion of the memory module based on the authentication key; retrieving a portion of the data after authenticating access to the data; encrypting at least a portion of the data based on the encryption key to form encrypted data; and transmitting the encrypted data over the first interface.

In an eleventh aspect, in combination with one or more of the first aspect through the tenth aspect, the RPMB portion of the memory module is configured with a monotonic write counter for replay protection.

In a twelfth aspect, in combination with one or more of the first aspect through the eleventh aspect, transmitting the encrypted data over the first interface prevents snooping of the encrypted data by an unauthorized user.

In a thirteenth aspect, in combination with one or more of the first aspect through the twelfth aspect, deriving the authentication key comprises executing a key derivation function (KDF) based on the seed key.

In a fourteenth aspect, in combination with one or more of the first aspect through the thirteenth aspect, the KDF is based on a cryptographic hash function.

In a fifteenth aspect, in combination with one or more of the first aspect through the fourteenth aspect, the method includes receiving encrypted data over the first interface from the host device; decrypting the encrypted data to obtain decrypted data based on the encryption key; authenticating access to the RPMB portion of the memory module based on the authentication key; and storing the decrypted data to the RPMB portion of the memory module after authenticating access.

In a sixteenth aspect, in combination with one or more of the first aspect through the fifteenth aspect, processing data on the first interface based on the encryption key comprises encrypting or decrypting data according to confidentiality algorithm.

In a seventeenth aspect, in combination with one or more of the first aspect through the sixteenth aspect, processing data on the first interface comprises storing or retrieving the data over the first channel with a universal flash storage (UFS) device.

In an eighteenth aspect, in combination with one or more of the first aspect through the seventeenth aspect, an apparatus includes a memory controller of a host device configured to couple the host device to a memory system through a first interface, the memory controller configured to perform operations including determining a seed key; deriving an authentication key based on the seed key, the authentication key for authenticating access to data stored in a replay protection memory block (RPMB) portion of the memory system; encrypting at least a portion of the data based on the encryption key to form encrypted data; and transmitting the encrypted data over the first interface.

In a nineteenth aspect, in combination with one or more of the first aspect through the eighteenth aspect, the operations further include transmitting a read request for the data to the memory system through the first interface prior to processing data on the first interface; retrieving encrypted data from the first interface, wherein processing the data on the first interface comprises decrypting the encrypted data based on the encryption key.

In a twentieth aspect, in combination with one or more of the first aspect through the nineteenth aspect, the RPMB portion of the memory module is configured with a monotonic write counter for replay protection.

In a twenty-first aspect, in combination with one or more of the first aspect through the twentieth aspect, the operations include encrypting data for a write request for the RPMB portion based on the encryption key; and transmitting the data for the write request for the RPMB portion to the memory system through the first interface.

In a twenty-second aspect, in combination with one or more of the first aspect through the twenty-first aspect, transmitting the data over the first interface after encrypting the data prevents snooping of the encrypted data by an unauthorized user.

In a twenty-third aspect, in combination with one or more of the first aspect through the twenty-second aspect, the operations include deriving the authentication key comprises executing a key derivation function (KDF) based on the seed key.

In a twenty-fourth aspect, in combination with one or more of the first aspect through the twenty-third aspect, the KDF is based on a cryptographic hash function.

In a twenty-fifth aspect, in combination with one or more of the first aspect through the twenty-fourth aspect, processing data on the first interface comprises storing or retrieving the data over the first channel with a universal flash storage (UFS) device.

In a twenty-sixth aspect, the memory controller comprises an in-line cryptography engine (ICE) coupled to the first interface and configured for encrypting or decrypting data according to a confidentiality algorithm using the encryption key.

In a twenty-seventh aspect, in combination with one or more of the first aspect through the twenty-sixth aspect, a method includes determining, at a memory controller of a host device, a seed key; deriving, by the memory controller of the host device, an authentication key based on the seed key, the authentication key for authenticating access to data stored in a replay protection memory block (RPMB) portion of a memory system; deriving, by the memory controller of the host device, a encryption key based on the authentication key; and processing, by the memory controller of the host device, data on a first interface coupling the memory controller of the host device to a memory system, wherein the processing of the data is based on the encryption key.

In a twenty-eighth aspect, in combination with one or more of the first aspect through the twenty-seventh aspect, the method or operations further include transmitting a read request for the data to the memory system through the first interface prior to processing the data on the first interface based on the encryption key; retrieving encrypted data from the first interface, wherein processing the data on the first interface comprises decrypting the encrypted data based on the encryption key.

In a twenty-ninth aspect, in combination with one or more of the first aspect through the twenty-eighth aspect, the RPMB portion of the memory module is configured with a monotonic write counter for replay protection.

In a thirtieth aspect, in combination with one or more of the first aspect through the twenty-ninth aspect, deriving the authentication key comprises executing a key derivation function (KDF) based on the seed key.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-6 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIG. 4A, 4B, 5A, or 5B may be combined with one or more blocks (or operations) described with reference to another of the figures. For example, one or more blocks (or operations) of FIG. 1 may be combined with one or more blocks (or operations) of FIG. 3. As another example, one or more blocks associated with FIG. 1 may be combined with one or more blocks (or operations) associated with FIG. 4A, 4B, 5A, or 5B. Additionally, or alternatively, one or more operations described above with reference to FIGS. 1-2 may be combined with one or more operations described with reference to FIGS. 4-5.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower” or “front” and back” or “top” and “bottom” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. An apparatus, comprising:
a memory controller:
coupled to a memory module through a first channel and configured to access data stored in the memory module through the first channel; and
coupled to a host device through a first interface and configured to communicate with the host device over the first interface, the memory controller configured to perform operations comprising:
receiving a seed key from the host device;
deriving an authentication key based on the seed key, the authentication key for authenticating access to data stored in a replay protection memory block (RPMB) portion of the memory module;
controlling access to the RPMB portion of the memory module based on the authentication key;
deriving an encryption key based on the seed key; and
processing data on the first interface based on the encryption key.

2. The apparatus of claim 1, wherein the memory controller is further configured to perform operations comprising:
authenticating access to the data stored in the RPMB portion of the memory module based on the authentication key;
retrieving a portion of the data after authenticating access to the data;
encrypting at least a portion of the data based on the encryption key to form encrypted data; and
transmitting the encrypted data over the first interface.

3. The apparatus of claim 2, wherein the RPMB portion of the memory module is configured with a monotonic write counter for replay protection.

4. The apparatus of claim 2, wherein transmitting the encrypted data over the first interface prevents snooping of the encrypted data by an unauthorized user.

5. The apparatus of claim 1, wherein deriving the encryption key comprises executing a key derivation function (KDF) based on the seed key.

6. The apparatus of claim 5, wherein the KDF is based on a cryptographic hash function.

7. The apparatus of claim 1, wherein the memory controller is further configured to perform operations comprising:
receiving encrypted data over the first interface from the host device;
decrypting the encrypted data based on the encryption key to obtain decrypted data;
authenticating access to the RPMB portion of the memory module based on the authentication key; and
storing the decrypted data to the RPMB portion of the memory module after authenticating access.

8. The apparatus of claim 1, wherein the memory controller comprises a cryptography engine configured to encrypt data retrieved from the RPMB portion of the memory module and configured to decrypt data for writing into the RPMB portion of the memory module.

9. (canceled)

10. A method, comprising:
receiving, at a memory controller of a memory system, a seed key from a host device over a first interface between the memory controller and the host device;
deriving, at the memory controller, an authentication key based on the seed key, the authentication key for authenticating access to data stored in a replay protection memory block (RPMB) portion of a memory module coupled to the memory controller through a first channel;
deriving, by the memory controller, an encryption key based on the seed key; and
processing, by the memory controller, data on the first interface based on the encryption key.

11. The method of claim 10, further comprising:
authenticating access to the data stored in the RPMB portion of the memory module based on the authentication key;
retrieving a portion of the data after authenticating access to the data;
encrypting at least a portion of the data based on the encryption key to form encrypted data; and
transmitting the encrypted data over the first interface.

12. (canceled)

13. The method of claim 11, wherein transmitting the encrypted data over the first interface prevents snooping of the encrypted data by an unauthorized user.

14. The method of claim 10, wherein deriving the encryption key comprises executing a key derivation function (KDF) based on the seed key.

15. (canceled)

16. The method of claim 10, further comprising:
receiving encrypted data over the first interface from the host device;
decrypting the encrypted data to obtain decrypted data based on the encryption key; authenticating access to the RPMB portion of the memory module based on the authentication key; and
storing the decrypted data to the RPMB portion of the memory module after authenticating access.

17. The method of claim 10, wherein processing data on the first interface based on the encryption key comprises encrypting or decrypting data according to a confidentiality algorithm.

18. (canceled)

19. An apparatus, comprising:
a memory controller of a host device configured to couple the host device to a memory system through a first interface, the memory controller configured to perform operations including:
determining a seed key;
transmitting the seed key to the memory system through the first interface;
deriving an authentication key based on the seed key, the authentication key for authenticating access to data stored in a replay protection memory block (RPMB) portion of the memory system;
deriving an encryption key based on the seed key;
accessing the RPMB portion of the memory system based on the authentication key; and
processing data on the first interface based on the encryption key.

20. The apparatus of claim 19, wherein the memory controller is configured to perform operations comprising:
transmitting a read request for the data to the memory system through the first interface prior to processing data on the first interface; and
retrieving encrypted data from the first interface, wherein processing the data on the first interface comprises decrypting the encrypted data based on the encryption key.

21. (canceled)

22. The apparatus of claim 19, wherein the memory controller is configured to perform operations comprising:
encrypting data for a write request for the RPMB portion based on the encryption key; and
transmitting the data for the write request for the RPMB portion to the memory system through the first interface.

23. The apparatus of claim 22, wherein transmitting the data over the first interface after encrypting the data prevents snooping of the encrypted data by an unauthorized user.

24. The apparatus of claim 19, wherein deriving the encryption key comprises executing a key derivation function (KDF) based on the seed key.

25. (canceled)

26. The apparatus of claim 19, wherein the memory controller comprises an in-line cryptography engine (ICE) coupled to the first interface and configured for encrypting or decrypting data according to a confidentiality algorithm using the encryption key.

27-30. (canceled)
